(19) United States
(12) Patent Application Publication
(10) Pub. No.: US 2005/0096006 A1
(43) Pub. Date: May 5, 2005

(54) Subscriber selectable alternative to audible ringback signals

(75) Inventors: Ben-Ren Chen, Northborough, MA (US); Robert Ephraim, Bridgewater, NJ (US)

Correspondence Address: McDERMOTT, WILL & EMERY, 600 13th Street, N.W., Washington, DC, 20005-3096, US

(73) Assignee: CELLCO PARTNERSHIP (d/b/a Verizon Wireless)

(21) Appl. No.: 10/697,161

(22) Filed: Oct. 31, 2003

(51) Int. Cl. H04M 9/00

(52) U.S. Cl. 455/400; 455/401

(57) ABSTRACT

A telephone call processing arrangement establishes a path between a called switching center and an audio content server in response to receipt of an incoming call to a subscriber. A preselected audio presentation is transmitted from the audio content server to the caller in lieu of audible ringback signals. A call leg is then extended from the called switching center to the called or forwarded station and, in response to an answer of the call by the called party, the audio content server is disconnected from the caller while the caller is connected to the call leg. Such provision may be employed for a mobile or landline subscriber.

### TECHNICAL FIELD

The present disclosure relates to a telecommunications service, more particularly in the provision of an audio presentation in lieu of audible ringback tone signals.

### BACKGROUND

During placement of a telephone call, a ringing tone, known as ringback, is conventionally provided to the calling device, audibly to be heard by the caller when the called telephone is ringing or otherwise alerting the called party of the incoming call. Conventionally, the ringing tone is a low tone which is ON for one second and OFF for three seconds, in repetition. The ringing tone is produced, not by the calling party's central switching office, but by the called party's central switching office. The ringback signal is not the same signal as the ringing at the called telephone.

In a typical CCIS type call processing method, the local calling central office suspends the call in order to signal the called station central office. The receiving central office determines whether or not the called station is busy. If the called station is busy, the receiving central office so informs the originating central office which in turn provides a busy signal to the calling station. If the called station is not busy, the receiving central office so informs the originating central office. A telephone connection is then constructed via the trunks and central offices of the network between the calling and called stations. The receiving central office then provides a ringing signal to the called station and sends ringback tones back through the connection to the calling station.

If the called party is not immediately available to answer the telephone or cannot answer, the ringback period may last for a considerable amount of time. If the call is to be forwarded to a third location or to voicemail, further delay in completion of the call can be experienced. The familiar intermittent ringing can become annoying to the caller as the dead time waiting for an answer to the call is extended.

Calls placed to cellular or PCS stations usually incur even greater processing delays. As the called station is mobile, its location at the time of the caller must be established. The appropriate mobile switching center and base station for the called station must be identified. If the station is in a remote or roaming region, an additional mobile switching center may be involved in the call setup. Thus it is likely that signaling communication between the calling central office or switching center and the mobile switching center at the region in which the called station is located will take longer than a typical landline telephone call. As ringback is provided by the destination switching center, the time between placement of the call and generation of ringback tones by the remote mobile switching center will be increased by the additional processing time. Completion of the call to the called mobile station will be further increased, thereby incurring an increased ringback time period.

The need thus exists for an alternative means to indicate to a caller that the call is being processed. The need also exists for a service in which a more palatable audio content can be presented to the caller in lieu of conventional ringback tones. A further need exists for the capability of extending the portion of the call processing time period during which such alternative audio content is provided.

### TECHNICAL SUMMARY

The present disclosure fulfills the aforementioned needs, at least in part, by providing telephone call processing that establishes a path between the called switching center and an audio content server in response to receipt of the incoming call and transmits a preselected audio presentation from the audio content server to the caller in lieu of audible ringback signals. A call leg is then extended from the called switching center to the called or forwarded station and, in response to an answer of the call by the called party, the audio content server is disconnected from the caller while the caller is connected to the call leg.

Such processing would be of particular benefit in a call placed to a mobile station. A call path to the audio content server would be established from information contained in a called subscriber Home Location Register database that associates the subscriber terminal with an alternative ringback service feature. The called destination is identified by querying the Home Location Register database. If the subscriber station is in a roaming location, a temporary routing number for the subscriber station is established.

A further benefit is that the audio content server may store a plurality of different audio presentations that can be pre-designated by a called party subscriber. The audio presentations may be varied in content to include musical selections, prerecorded messages, advertising messages and the like. The called party subscriber may designate criteria for selection of a particular one of the stored presentations for each incoming call. Such criteria may include, for example, the identity of the caller, the geographical location of the origination of the call, and the time of day of the incoming call. Thus, in accordance with specified criteria, for example, an audio presentation for a morning call may be different from an audio presentation transmitted for a night call.

Additional advantages of the present disclosure will become readily apparent to those skilled in this art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description are to be regarded as illustrative in nature, and not as restrictive.

### BRIEF DESCRIPTION OF DRAWINGS

The drawing figures depict the present invention by way of example, not by way of limitations. In the figures, like reference numerals refer to the same or similar elements.

FIG. 1 is a simplified block diagram of a telecommunication system in accordance with the present disclosure.

FIG. 2 is a flow diagram that illustrates a call process for a call placed to a mobile station that subscribes to the alternative ringback feature when that station is in its home MSC location.

FIG. 3 is a flow diagram that illustrates a call process for a call placed to a mobile station that subscribes to the alternative ringback feature when that station is in a roaming location.

FIG. 4 is a flow diagram that illustrates a call process for a call placed to a mobile station that subscribes to the alternative ringback feature when that station has an applied unconditional call forwarding feature.

FIG. 5 is a flow diagram that illustrates a call process for a call placed to a mobile station that subscribes to the alternative ringback feature when that station when call forwarding is not active and the mobile station is powered off at the time of the call.

FIG. 6 is a flow diagram that illustrates a call process for a call placed to a mobile station that subscribes to the alternative ringback feature with an applied call forwarding-busy service when that station that station is busy.

FIG. 7 is a flow diagram that illustrates a call process for a call placed to a mobile station that subscribes to the alternative ringback feature with no active call forwarding when that station is busy.

FIG. 8 is a flow diagram that illustrates a call process for a call placed to a mobile station that subscribes to the alternative ringback feature that encounters call collision with call forwarding not active.

FIG. 9 is a flow diagram that illustrates a call process for a call placed to a mobile station that subscribes to the alternative ringback feature with an applied call forwarding if the mobile station does not answer.

FIGS. 10 and 11 are flow diagrams for call processes for a call placed to a mobile station that subscribes to the alternative ringback feature that encounter trunk congestion with release from PSTN when call forwarding is active without answer or not active.

FIG. 12 is a flow diagram that illustrates a call process for a call placed to a mobile station that subscribes to the alternative ringback feature with interaction with intersystem paging.

FIG. 13 is a flow diagram that illustrates a call process for a call placed to a prepaid mobile station that subscribes to the alternative ringback feature.

FIG. 14 is a flow diagram that illustrates a call process for a call placed to a prepaid mobile station that subscribes to the alternative ringback feature with unconditional call forwarding applied.

### DETAILED DESCRIPTION

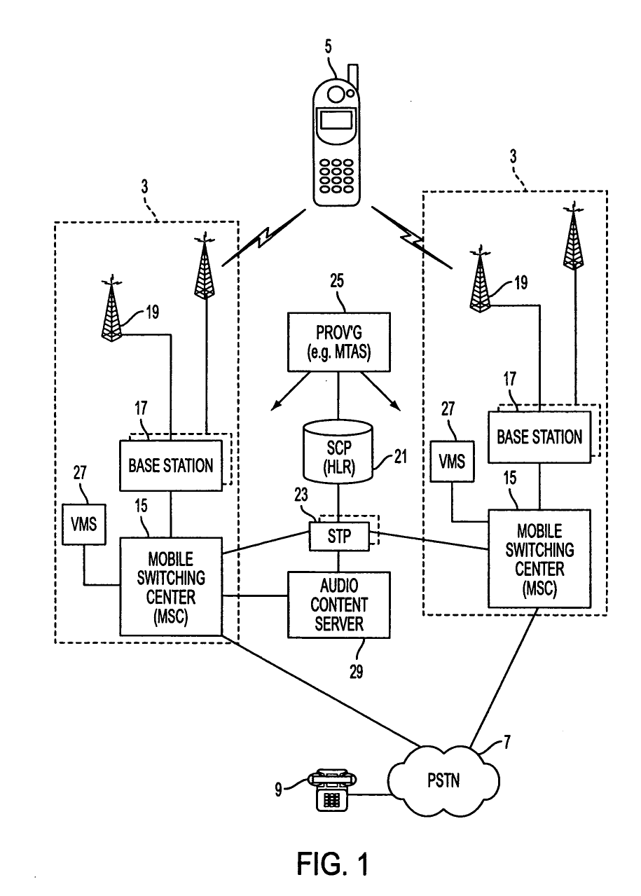

FIG. 1 depicts a communication system for providing voice telephone communications. Regional wireless communication networks 3 provide wireless telephone or personal communications service (PCS) type services to mobile stations depicted by way of example as a mobile handset 5 in different service areas. Each network 3 enables users of the mobile stations 5 to initiate and receive telephone calls to each other as well as through the public switched telephone network (PSTN) 7 to telephone devices 9. Wireless communication services may be provided in accordance with a digital protocol or an analog protocol or both. Each regional network 3 includes a mobile switching center (MSC) 15. Each MSC connects through trunk circuits to a number of base stations 17, which are under the control of the respective MSC.

The base station 17, or base transceiver system (BTS), is the part of the radio network 3 that sends and receives RF signals to/from the mobile stations 5 that the base station currently serves. The base station connects to and communicates through the antenna systems on a radio tower 19. The base station contains the transmitters and receivers at a site and is responsible for the control, monitoring, and supervision of calls made to and from each mobile station 5 within its serving area, over the wireless air link. The base station assigns and reassigns channels to the mobile stations and monitors the signal levels to recommend hand-offs to other base stations (not shown).

Each network 3 typically includes a base station controller (BSC) functionality that controls the functions of a number of base stations 17 and helps to manage how calls made by each mobile station 5 are transferred (or “handed-off”) from one serving base station to another. Each wireless network equipment vender implements this function differently. Some vendors have a physical entity, which they call a BSC, while other vendors include this functionality as part of their mobile switching center (MSC). For convenience of illustration, it is assumed that the BSC functionality in the network 3 is incorporated into the MSC 15. Through the MSC and the base stations, the network provides voice-grade telephone services over the common air interface to and from the mobile stations. The network may include one or more additional elements (not separately shown), such as an inter-working function (IWF) or a Packet Data Serving Node (PDSN) to support data services over the logical communication channels of the wireless air interface, for example for communications via the Internet (not shown).

The network 3 typically utilizes a number of logical channels for to provide signaling related to the network services, for example for paging called stations, registration, and the like. For example, the network 3 sends alert messages to the mobile station 5 over the paging channel, when there is an incoming call to the station or an incoming data message (e-mail or the like). The paging channel alert message contains address information specifically identifying the particular mobile station 5, and possibly information distinguishing the particular type of incoming call or message. In the uplink direction, the mobile station registers with the network 3 serving the area in which the user is currently located. Once registered, the mobile station periodically sends messages to the network 3 over the uplink access channel, to maintain its registered station.

The mobile telephone station includes a transceiver compatible with the particular type of wireless network. The mobile stations 5, the MSCs 15 and the base stations 17 implement one or more standard air-link interfaces. For example, the wireless telephone network may support dual-mode services. Although not shown separately, such a dual-mode network includes wireless telephone components that output analog telephone signals for transmission according to an analog wireless protocol (e.g., AMPS) as well as digital wireless system components that operate in accordance with a digital wireless protocol, for example the CDMA protocol IS-95. The base stations may provide both types of services. Alternatively, the network may comprise base stations that send and receive voice and signaling traffic according to the prescribed analog protocol as well as digital base stations that utilize the digital wireless protocol. Each dual-mode MSC typically includes a switching subsystem for analog telephone services, a switching subsystem for digital telephone services, and a control subsystem. Other MSCs may implement only one type of service.

The digital wireless equipment may support any one of several common interface standards, including time division multiple access (TDMA), the Global System for Mobile communications (GSM) and code division multiple access (CDMA) standards. As will be familiar to those of ordinary skill, an air-link interface for each cellular service in a geographic area includes paging channels and/or signaling channels, as well as actual communications channels for voice and/or data services. The channels may be separate frequency channels, or the channels may be logically separated, for example based on time division or code division. The paging and signaling channels are used for preliminary coded communications between a cellular telephone and a cell site in setting up a telephone call or other session, after which a communication channel is assigned or set up for the telephone's use on that call.

The wireless network includes a Home Location Register (HLR) that stores subscriber profiles for each of the wireless subscribers and their associated digital wireless telephones 5. The HLR may reside in the home MSC or, as shown, in a centralized service control point (SCP) 21. The SCP 21 communicates with the MSCs 15 via data links and one or more signaling transfer points (STPs) 23 of an out-of-band signaling system, typically, an SS7 network. As recognized in the art, the HLR stores for each mobile subscriber the subscriber's mobile telephone number, the mobile identification number, and information specifying the wireless services subscribed to by the mobile subscriber, such as numeric paging or text-based paging, data communication services, multiple alerting, etc.

The carrier also operates a number of different systems in one or more customer service centers. These include one or more billing systems, client account administration systems, network provisioning systems 25 such as the Mobile Telephone Administration system or “MTAS”, and the like. The billing system (not shown), for example, receives usage and operations data from the MSCs 15 and processes that data to generate bills for individual customers and to forward data regarding users roaming through the carrier's service area through a clearinghouse (not shown) for reconciliation. The MTAS provides data to the HLR in the SCP 21 and/or to the MSCs 15 to provision services for new stations 5 and modifies provisioning data as customers change their subscriptions to obtain different sets of services from the carrier. Voice mail service (VMS) 27 may be provided directly linked to each MSC, as shown, or located at a central network site. Audio content server 29 is capable of storing a plurality of various prerecorded audio presentations for transmission over the wireless and PSTN networks. While illustrated as being coupled to an MSC 15 and STP 23, the audio content server may be located anywhere that trunk and signaling system links are available.

As a customer using a mobile station 5 roams into the service area of another system 3, the station 5 registers with that system. Service information is transferred from the HLR in the SCP 21 to a Visitor Location Register (VLR) in the visited access network during the successful registration process. Specifically, a visited wireless communication network assigns a register, as a VLR, to a mobile station 5 during a period when the station roams into the wireless serving area of the visited provider's network and remains registered on that visited system. The VLR communicates with the HLR in the SCP 21 to authenticate the mobile station 5 and obtain a copy of subscriber subscription service information, from the HLR during the registration process, typically via packet messages exchanged via the SS7 interoffice signaling network.

In a call placed to a telephone number of a wireless or mobile station 5 from a landline terminal 9 of PSTN network 7, the serving end office in the PSTN 7 recognizes the NPA-NXX digits in the dialed number as those of a carrier served through the tandem (not shown) that couples the PSTN to the called party's home MSC 15. The end office responds by routing the call to the tandem, and the tandem routes the call to the MSC 15 for completion to the destination station 5. If the station 5 is registered with the particular system 3 (i.e., within the home region), the MSC completes the call through the appropriate base station 17 and transmitter tower 19. If the station 5 is not registered with the home system 3 (i.e., not within the home region), the originating MSC 15 in that region routes the call to the MSC (serving system) in the region where the called station is currently registered as a visiting or roaming customer. The serving system may be a system of the same provider or a system operated by another provider. In the event that the called mobile station 5 does not answer, the MSC 15 designated as the home MSC may roll the call over to a voice mail system 15.

Some services utilize ‘intelligent’ call processing to provide advanced features, such as multiple alerting. For those kinds of services, the MSC 15 processing a call to or from a mobile station 5 will detect an event in call processing commonly referred to as a “trigger.” Upon hitting a trigger, the MSC 15 will communicate through the links and STP(s) 23 of the SS7 signaling network with a database in an SCP 21 to obtain instructions regarding further processing of the call. The SCP typically is the one that provides the HLR, although some features could utilize one or more additional SCPs. When the MSC that detected the trigger event has obtained sufficient information, it will continue processing of the call. Implementations of such Advanced Intelligent Network (AIN) processing may involve multiple triggers and associated exchanges between the MSC and one or more SCPs to determine how to complete each individual call in accordance with one or more AIN features provided to the user of the mobile station 5.

The system illustrated in FIG. 1 provides alternative ringback for calls to mobile customers that subscribe to this feature. The subscriber's home HLR 21 maintains the authorization status and activation status for this service on a per-subscriber basis. When a call arrives at the called subscriber's home MSC 15, illustrated as being within the network 3 at the left side of the drawing, the MSC sends an initial query to the HLR for the subscriber's location. The HLR determines whether this feature is active for the subscriber. If it is, the HLR responds with a message containing an indication that the incoming call should be connected to the audio content server 29. While this connection is made, the HLR database will locate the subscriber station 5, in response to a second request from the subscriber's home MSC. If the called subscriber is at a roaming location, the HLR, which maintains a pointer to the subscriber as the subscriber roams, obtains a temporary routing number from the MSC serving the location of the subscriber station, exemplified as that at the right side of the drawing. The temporary routing number is passed to the home MSC to extend a call leg to the MSC of the network at the subscriber's location. When the subscriber answers the incoming call leg, the home MSC disconnects the audio content server from the caller and connects the caller to the call leg to the subscriber to complete the call so that calling and called parties can converse.

Different signaling protocols and protocol elements can be used in providing this service. For example, in a wireless network that uses the TIA/EIA-41 protocol, the HLR could use a protocol extension field within the OneTimeFeatureIndicator parameter (OTFI) to inform the home MSC that the incoming call should be connected to the audio content server, and the HLR could use the RoutingDigits parameter to pass HLR stored routing information back to the HLR. In such a network, the home MSC and HLR could use Wireless Intelligent Network triggers and protocol standardized by the IS-771 extensions to TIA/EIA-41 to distinguish between the initial request for the subscriber's location and the second request for that location. The connection of the incoming call to the audio content server could be controlled using the ISUP protocol as standardized for use in North American networks by T1.113. In this case, the identity of the caller and of the called subscriber might be carried by the Calling Party Number parameter and the Redirecting Number parameter, respectively, although there are other parameters that could also be used. The routing information could be carried in the Called Party Number parameter.

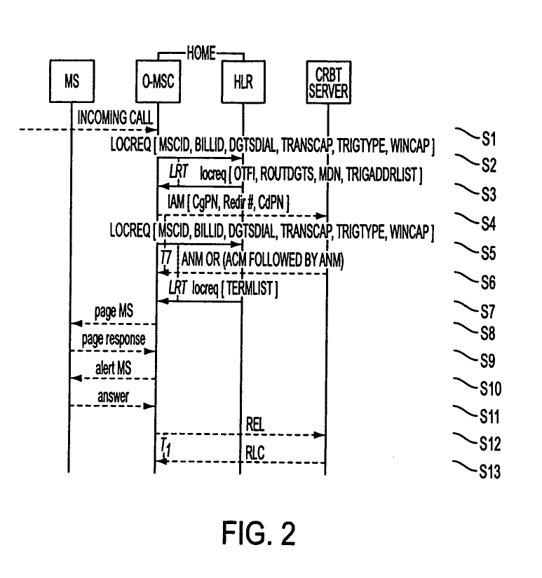

FIG. 2 is a flow diagram that illustrates a call process for a call placed to a mobile station that subscribes to the alternative ringback feature when that station is in its home MSC location. At the top of the diagram are blocks, horizontally spaced, which represent a called mobile station (MS) 5, the home originating mobile switching center (O-MSC) 15, HLR 21, and audio content server 29. The steps of the flow diagram are shown successively in the downward direction, interaction between participating blocks indicated by horizontal arrows with associated call processing parameters. At step S1, an incoming call is received at the O-MSC. The call may originate from a mobile station or a landline station. At step S2, the O-MSC detects a mobile termination trigger and sends a first location request (LOCREQ) to the HLR, seeking instructions on how to process the call. The parameters included in a location request are well known and summarized with their usage in the illustrated call process in the following table.

| Parameters | Usage |
|---|---|
| MSCID | The ID of the MSC. |
| BILLID | The Billing ID for the call. |
| DGTSDIAL | Digits identifying the called party. |
| TRANSCAP | Set to indicate the O-MSC's Transaction |
| | Capabilities, including support for the |
| | TriggerAddressList parameter. |
| TRIGTYPE | Indicates that the Mobile Termination trigger |
| | was encountered. |
| WINCAP | Set to indicate the O-MSC's WIN Capabilities. |

At step S3, the HLR examines the subscriber's list of services, which includes the alternative ringback feature and returns an answer message (loreq) to the O-MSC. The parameters of this message and usage are summarized in the following table.

| Parameters | Usage |
|---|---|
| OTFI | The RPE1 field in octet 3 of the OTFI is set to |
| | indicate that the alternative ringing feature is |
| | authorized and active. |
| ROUTDGTS | Set to the number to be used to route to the |
| | audio content server. |
| MDN | Set to the called subscriber's mobile directory |
| | number. |
| TRIGADDRLIST | Set to arm the Location trigger (for locating the |
| | mobile station). |

At step S4, the O-MSC sends an ISUP LAM message to extend a call leg trunk path towards the audio content server. The parameters of this message and usage are summarized in the following table.

| Parameter | Usage |
|---|---|
| CgPN | The phone number of the caller. |
| Redir# | Set to the called subscriber's MDN. |
| CdPN | Set to the number to be used to route to the |
| | audio content server as received in |
| | ROUTDGTS. |

At step S5, the O-MSC detects the Location trigger and sends another LOCREQ to the HLR. The parameters differ from those of first LOCREQ of step S2 in that the TRIGTYPE indicates that the Location trigger was encountered. At step S6, the audio content server either returns an ISUP answer message (ANM) or it returns an ISUP address complete message (ACM) not containing the cause parameter followed by an ISUP ANM toward the O-MSC and applies the appropriate audio presentation from the audio content server to the incoming call leg. In the illustrated example, the server determines that it has the resources to accept the incoming call leg and apply the audio presentation.

At step S7, the HLR determines that the mobile station MS is at home and returns a locreq to the O-MSC directing the O-MSC to deliver the call locally. The TERMLIST parameter contains a local termination. At step 8, the O-MSC pages the MS. At step 9, the MS responds to the page and the MS is brought up on a traffic channel. At step S10, the called party is alerted. At step S11, the called party answers the call. At step S12, the O-MSC disconnects the incoming call from the call leg to the audio content server, connects the incoming call to the MS, and sends an ISUP release (REL) message towards the audio content server. At step S13, the audio content server releases the call leg from the O-MSC and returns an ISUP RLC message towards the O-MSC. The O-MSC releases the trunk towards the audio content server.

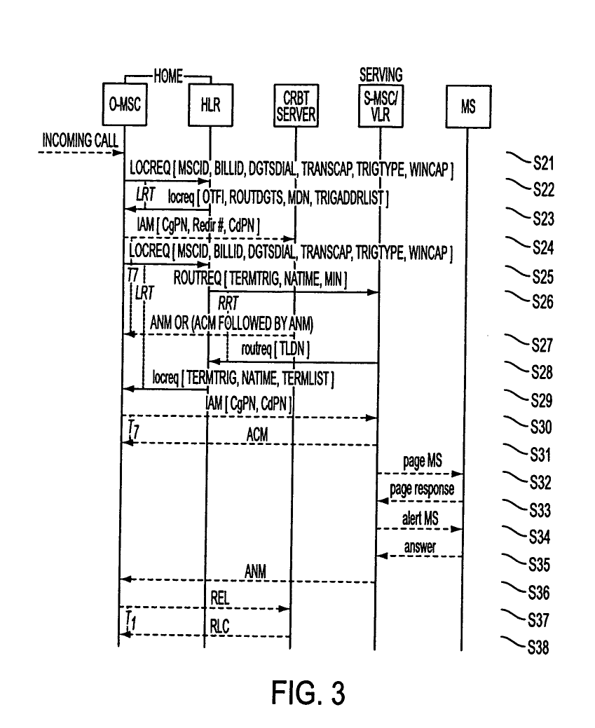

FIG. 3 is a flow diagram that illustrates a call process for a call placed to a mobile station that subscribes to the alternative ringback feature when that station is in a roaming location. The diagram includes an additional block that represents the remote, or serving, mobile switching center, designated S-MSC. Steps S21-S25 are the same as steps S1-S5 in FIG. 2. At step S26, the HLR sends a ROUTREQ to the serving system S-MSC. The parameters of that request and usage are summarized below.

| Parameter | Usage |
|---|---|
| TERMTRIG | Include if termination triggers are to be |
| | modified for the call. |
| NATIME | Include if applicable to inform the serving |
| | system of the recommended an-answer time for |
| | the call. |
| MIN | Include. |

At step S27, the server determines that it has the resources to accept the incoming call leg and apply to it an audio presentation. The server returns an immediate ISUP ANM or an ISUP ACM not containing the cause parameter followed by an ISUP ANM toward the O-MSC and applies the audio presentation. At step S28, the serving system S-MSC returns temporary location directory number in a routreq message to the HLR. The remaining steps are the same as or similar to those of FIG. 2, differing in that the call delivery leg is routed to the S-MSC.

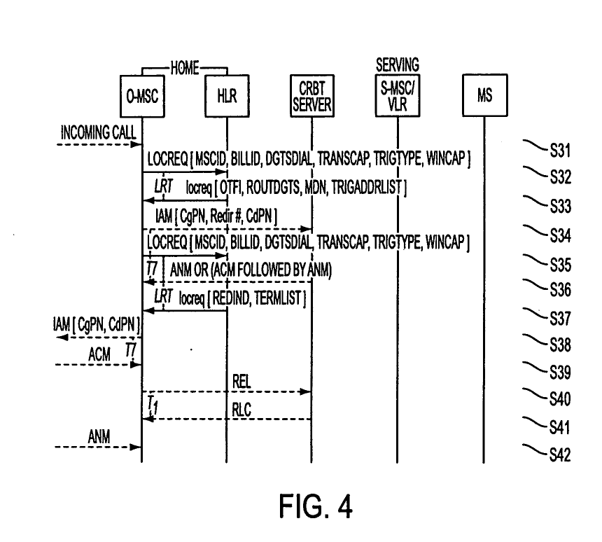

FIG. 4 is a flow diagram that illustrates a call process for a call placed to a mobile station that subscribes to the alternative ringback feature when that station has an applied unconditional call forwarding feature. Steps S41-S46 are the same or similar to steps S1-S6 of FIG. 2. At this point in the process the audio presentation has been applied to the incoming call leg. At step S47, the HLR determines that the call forwarding feature is applicable and returns a locreq request to the O-MSC directing it to forward the call. In the illustrated case, the call is forwarded to a third party's phone number. The parameters of that request and usage are summarized in the following table.

| Parameter | Usage |
|---|---|
| REDIND | Indicates call forwarding as the reason for |
| | forwarding the call. |
| TERMLIST | Contains a PSTN Termination containing |
| | DestinationDigits set to the forward-to number. |

At step S48, the O-MSC sends an ISUP IAM message to route the call leg to the forward-to number. The parameters of that request and usage are summarized in the following table.

| Parameter | Usage |
|---|---|
| CgPN | The phone number of the caller. |
| CdPN | Set to the forward-to number. |

At step S49, the O-MSC receives an ISUP ACM for the call leg to the forward-to party. At step S50, the MSC disconnects the incoming call from the call leg toward the audio content server, connects the incoming call leg to the call leg to the forward-to party, and sends an ISUP REL message to the audio content server. At step S51, the server releases the call leg from the O-MSC and returns an ISUP RLC message towards the MSC. The O-MSC releases the trunk towards the server. At step S52, the O-MSC receives an ISUP ANM for the call leg to the forward-to party. Since the application of the audio presentation to the calling party ended when call progress information for the forwarded call becomes available, the caller thus would be able to learn if the forwarded leg encounters network congestion or a busy condition. If the forward-to party is a subscriber to the alternative ringing feature, the calling party may then be presented with audio content associated with the forward-to party.

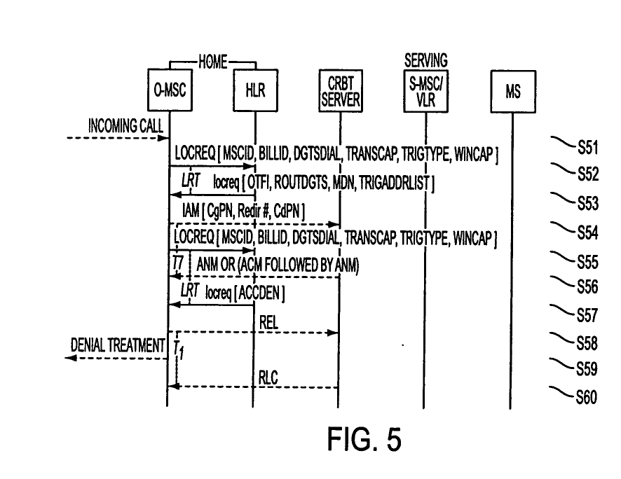

FIG. 5 is a flow diagram that illustrates a call process for a call placed to a mobile station that subscribes to the alternative ringback feature when that station when call forwarding is not active and the mobile station is powered off at the time of the call. Steps S61-S66 are the same or similar to steps S1-S6 of FIG. 2. At this point in the process the audio presentation has been applied to the incoming call leg. At step S67, the HLR determines that the mobile station is inactive and that call forwarding service is not active. The HLR returns a locreq to the O-MSC directing the O-MSC to deny access. The parameter ACCDEN indicates that access is denied because the mobile station is inactive. At step S68, the O-MSC disconnects the incoming call from the call leg to the audio content server and sends an ISUP REL message towards the audio content server. At step S69, the O-MSC applies the appropriate denial treatment to the caller. At step S70, the audio content server releases the call leg from the O-MSC and returns an ISUP RLC message towards the O-MSC. The O-MSC releases the trunk towards the audio content server.

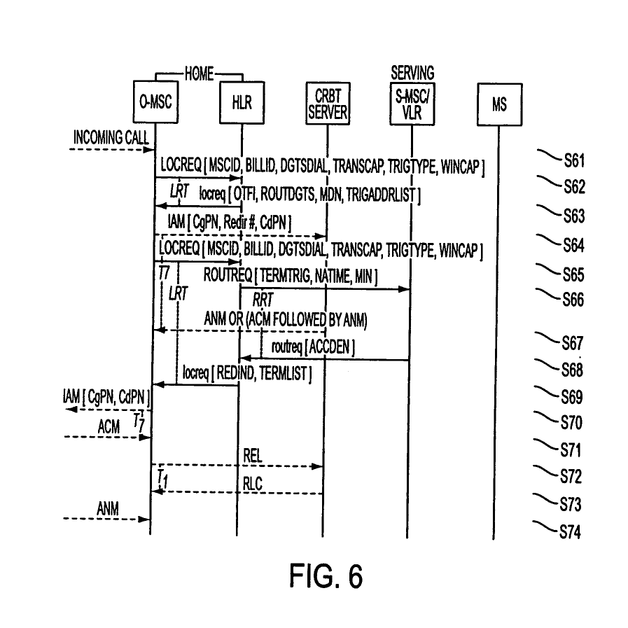

FIG. 6 is a flow diagram that illustrates a call process for a call placed to a mobile station that subscribes to the alternative ringback feature with an applied call forwarding-busy service when that station that station is busy. Steps S81-S87 are the same or similar to steps S21-S27 of FIG. 3. At this point in the process the audio presentation has been applied to the incoming call leg. At step S88, the serving system determines that the mobile station is busy and returns a locreq to the HLR indicating the busy status. The parameter ACCDEN indicates that access is denied because the mobile station is busy. At step S89, the HLR determines that call forwarding applies and returns a locreq to the O-MSC directing the O-MSC to forward the call, in this case to a third party's number. The locreq contains the parameters REDIND and TERMLIST such as described above. Steps S90-S94 are the same or similar to steps S48-S52 in FIG. 4 to effect forwarding of the call.

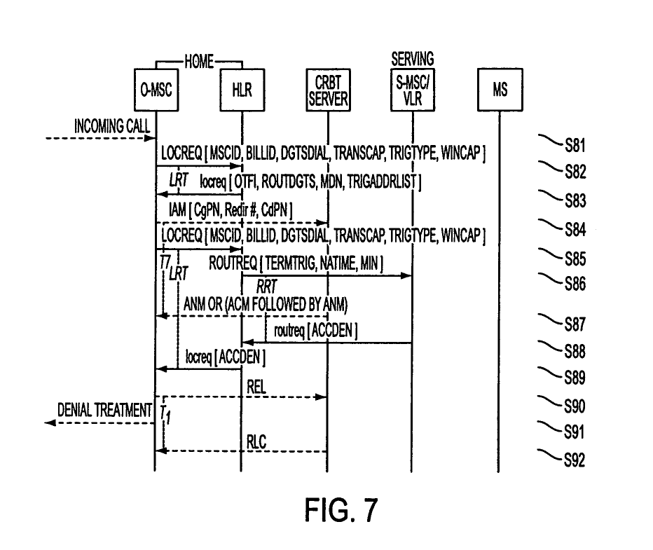

FIG. 7 is a flow diagram that illustrates a call process for a call placed to a mobile station that subscribes to the alternative ringback feature with no active call forwarding when that station is busy. Steps S101-S108 are the same or similar to steps S81-S88 in FIG. 6, the audio presentation having been applied to the incoming call leg. At step S109, the HLR determines that call forwarding is not active. The HLR returns a locreq to the O-MSC directing the O-MSC to deny access. Steps S1110-S112 are the same as or similar to steps S68-S70 of FIG. 5, wherein the incoming call is disconnected from the call leg to the audio content server and appropriate denial treatment is applied to the caller.

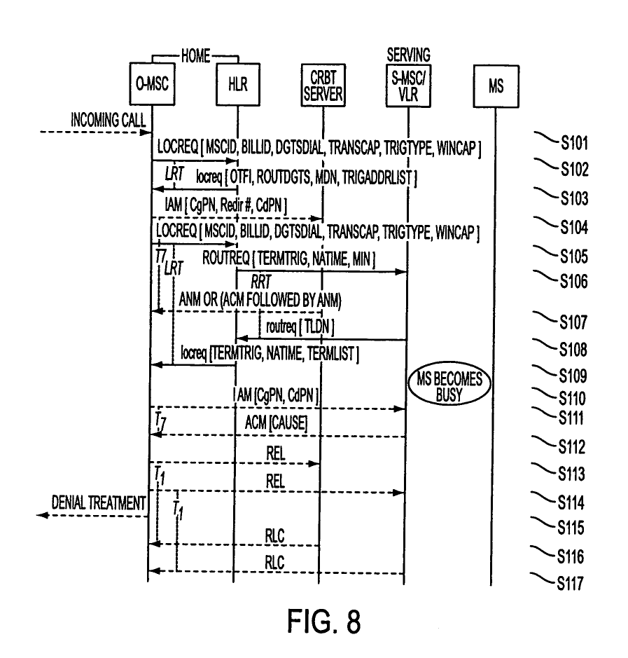

FIG. 8 is a flow diagram that illustrates a call process for a call placed to a mobile station that subscribes to the alternative ringback feature that encounters call collision with call forwarding not active. An example is depicted in which the called subscriber is located outside the home location and processing has progressed in steps S121-S129 as in steps S21-S29 of FIG. 3. After the serving system has sent a temporary location directory number to the HLR, the mobile station becomes engaged in another call, indicated by step S130, such as by its own origination or by arrival of an inter-MSC call from a previous routreq. At step S131, the O-MSC sends an ISUP IAM with busy cause to route the call delivery leg to the S-MSC, with appropriate CgPN and CdPN parameters. At step S132, the S-MSC recognizes that the mobile station is busy and that call waiting, call forwarding and the like are not applicable for the incoming call. The S-MSC returns an ISUP ACM toward the O-MSC and applies in-band busy tones to the incoming call delivery leg. At step S133, the O-MSC recognizes that the mobile station is busy and that the busy termination trigger is not active. The O-MSC disconnects the incoming call from the call leg to the audio content server and sends an ISUP REL message towards the server. The S-MSC, alternatively, may be configured to release the call delivery leg back toward the O-MSC, rather than playing the busy tone itself. At step S134, which may occur concurrently with step S133, the O-MSC sends an ISUP REL message for the call delivery leg towards the S-MSC. At step S135, The O-MSC applies the appropriate denial treatment to the caller. At step S136, the audio content server releases the call leg from the O-MSC and returns an ISUP RLC message towards the O-MSC. The O-MSC releases the trunk towards the audio content server. At step S137, the S-MSC releases the call delivery leg and returns an ISUP RLC towards the O-MSC. The O-MSC releases the call delivery leg.

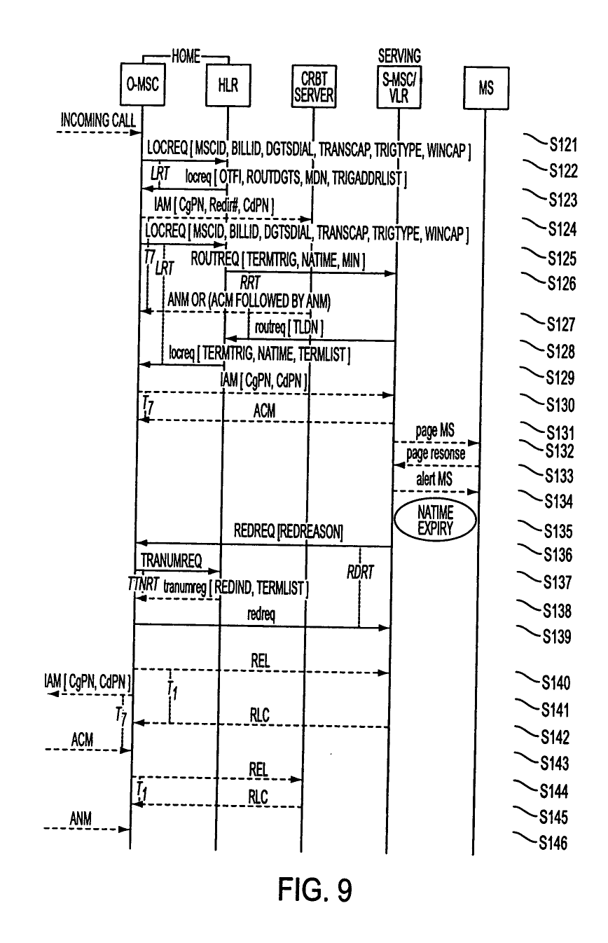

FIG. 9 is a flow diagram that illustrates a call process for a call placed to a mobile station that subscribes to the alternative ringback feature with an applied call forwarding if the mobile station does not answer. Steps S141-S154 are the same or similar to steps S21-S34 in FIG. 3. The call has progressed to the point of alerting the mobile station to the incoming call. At step S155 a no answer timer has expired. At step S156, the S-MSC sends a REDREQ message to the O-MSC, which indicates that the call is being redirected because of no answer. At step S157, the O-MSC sends a TRANUMREQ message to the HLR to transfer the destination number. At step S158, the HLR returns a tranumreq message, REDIND and TERMLIST parameters, to the O-MSC directing the O-MSC to forward the call. At step S159, the O-MSC sends a redreq message to the S-MSC. At step S160, the O-MSC sends an ISUP REL message for the call delivery leg towards the S-MSC. At step S161, the O-MSC sends an ISUP LAM message to route the call to the forward-to party. At step S162, the S-MSC releases the call delivery leg and returns an ISUP RLC message towards the O-MSC. Steps S163-S166 are the same as or similar to steps to S49-S52 of FIG. 4.

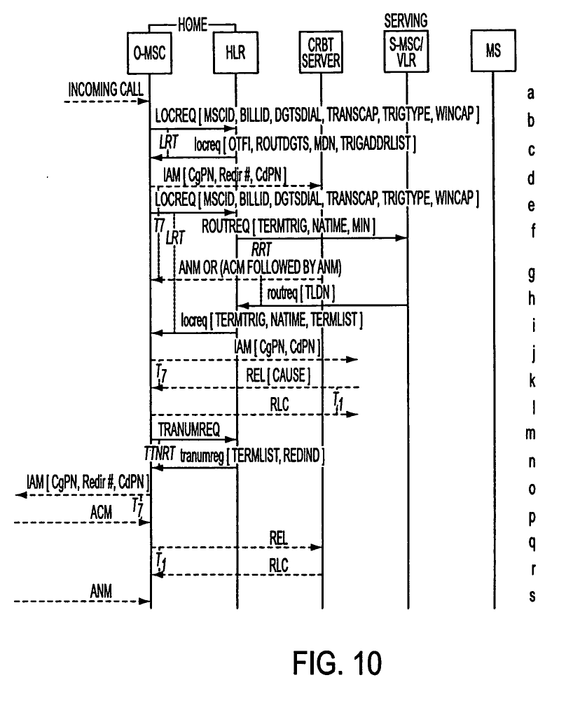

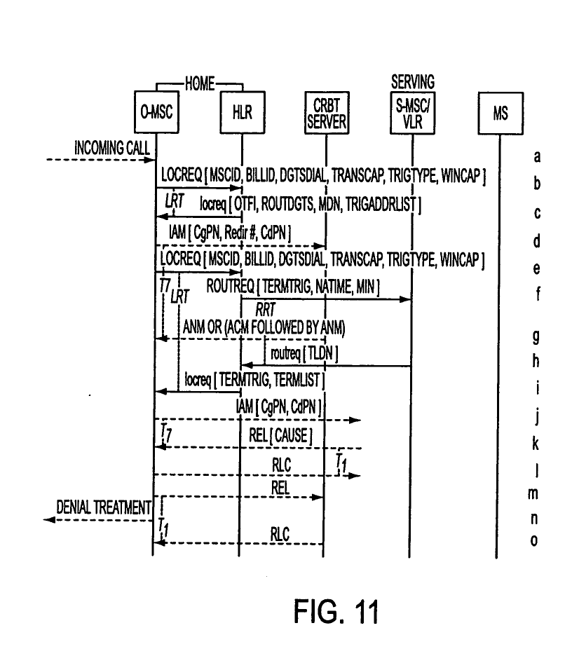

FIGS. 10 and 11 are flow diagrams for call processes for a call placed to a mobile station that subscribes to the alternative ringback feature that encounter trunk congestion with release from PSTN when call forwarding is active without answer or not active. The various illustrated steps of the processes are similar to process steps previously described.

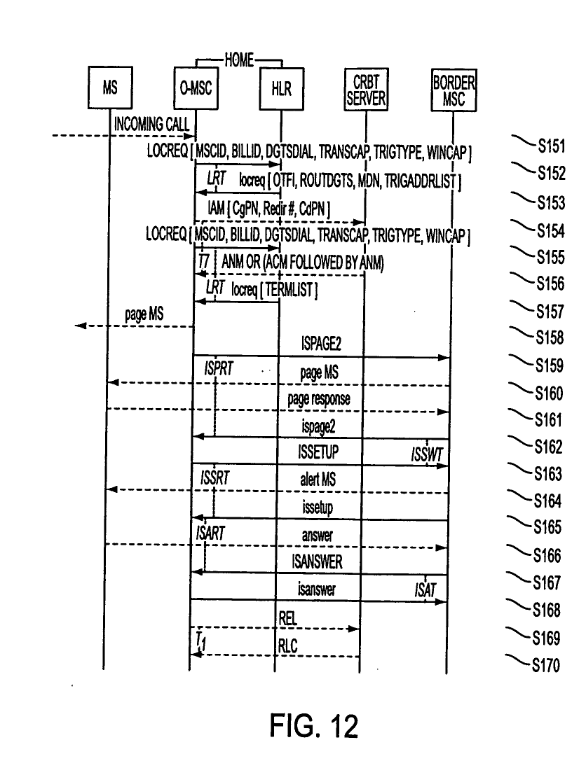

FIG. 12 is a flow diagram that illustrates a call process for a call placed to a mobile station that subscribes to the alternative ringback feature with interaction with intersystem paging. Steps S171-S178 are the same or similar to steps S1-S8 of FIG. 2. At this point in the call process, the O-MSC has paged the mobile station. At step S179, the O-MSC sends an ISPAGE2 message to one or more border MSCs. At step S180, the border MSC pages the mobile station. At step S181, the mobile station responds to the page from the border MSC. At step S182, the mobile station is assigned to a traffic channel and the border MSC returns an ispage2 to the O-MSC. At step S183, the O-MSC sends an ISSETUP message to the border MSC to setup an intersystem trunk. At step S184, the border MSC alerts the mobile station. At step S185, the border MSC connects audible ringing to the intersystem trunk and returns an issetup to the O-MSC. Because the alternative ringback feature is being provided, the O-MSC does not connect the incoming call leg to the intersystem trunk at this time. Instead, it leaves the incoming call leg connected to the audio content server. At step S186, the mobile station answers the call. At step S187, the border MSC removes audible ringing from the intersystem trunk, connects the mobile station to the intersystem trunk, and sends an ISANSWER message to the O-MSC. At step S188, the O-MSC returns an answer to the O-MSC. At step S189, the O-MSC disconnects the incoming call from the call leg to the audio content server, connects the incoming call to the intersystem trunk, and sends an ISUP REL message towards the audio content server. At step S190, the audio content server releases the call leg from the O-MSC, and returns an ISUP RLC towards the O-MSC. the O-MSC releases the trunk towards the audio content server.

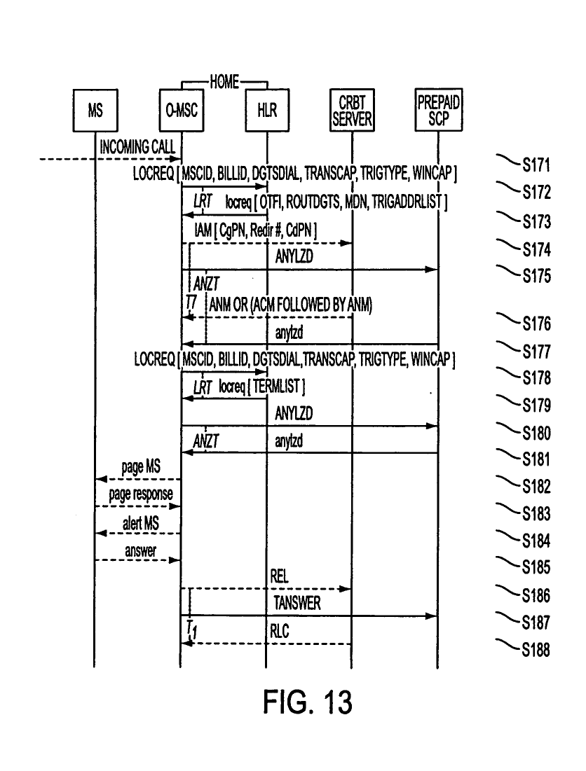

FIG. 13 is a flow diagram that illustrates a call process for a call placed to a prepaid mobile station that subscribes to the alternative ringback feature. Although local termination is exemplified, additional processing for a roaming location would be handled in a manner similar to that previously described. At steps S191 and S192, an incoming call is received at the O-MSC, detects a mobile termination trigger and sends a LOCREQ message to the HLR, seeking instructions on how to process the call. At step S193, the HLR returns a locreq to the O-MSC. The parameters and usage are summarized in the following table.

| Parameter | Usage |
|---|---|
| OTFI | The RPE1 field in octet 3 of the OTFI is set to |
| | indicate that alternative ringback is authorized |
| | and active. |
| ROUTDGTS | Set to the number to be used to route to the |
| | audio content server. |
| MDN | Set to the called subscribers' mobile directory |
| | number. |
| TRIGADDRLIST | Set to arm the Initial_Termination, Location, |
| | Called_Routing_Address_Available, |
| | T_Answer, and T_Disconnect triggers. |

At step S194, the O-MSC sends an ISUP IAM message to extend a call leg trunk path towards the audio content server, as described with respect to FIG. 2. At step S195, The O-MSC detects the Initial_Termination trigger and sends a ANLYZD message to the prepaid SCP associated with the mobile station. The TriggerType parameter is set to indicate that the Initial_Termination trigger was detected. Step S196 is the same as or similar to step S6 of FIG. 2. At step S197, the SCP determines that the called subscriber has prepaid service active and that the account balance is above the threshold level. The SCP sends an anlyzd message to the O-MSC. The DMH_SVCID parameter is set to indicate that the prepaid service was invoked. Steps S198 and S199 are the same, respectively, as steps S5 and S7 of FIG. 2. At step S200, the O-MSC detects the Called_Routing_Address_Available trigger and sends an ANLYZD messaged to the prepaid SCP associated with the mobile subscriber. The TriggerType parameter is set to indicate that the Called_Routing_Address_Available trigger was detected. At step S201, the SCP sends an anlyzd message to the O-MSC. Steps S202-S206 are the same as or similar to steps S8-S12 of FIG. 2. At step S207, the O-MSC detects the T Answer trigger and sends a TANSWER message to the prepaid SCP associated with the mobile station. At step S208, the audio content server releases the call leg from the O-MSC and returns an ISUP RLC message towards the O-MSC. The O-MSC releases the trunk towards the audio content server.

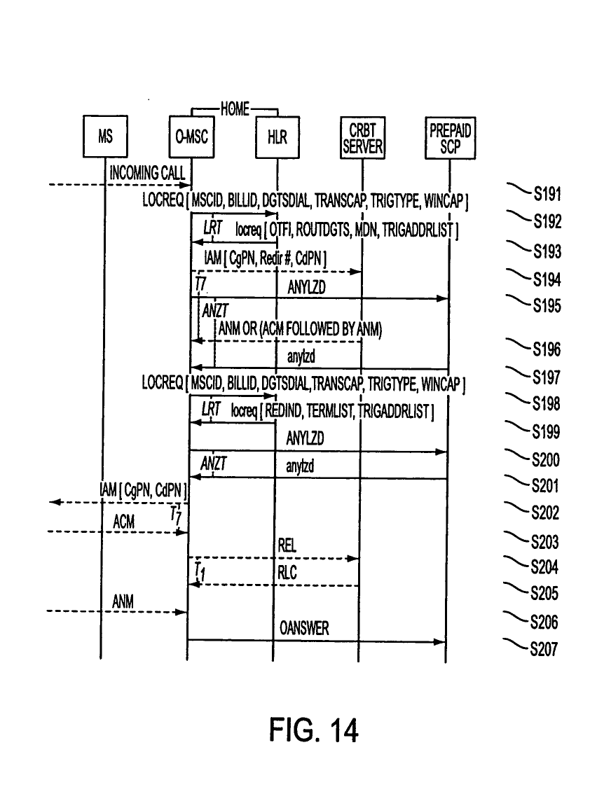

FIG. 14 is a flow diagram that illustrates a call process for a call placed to a prepaid mobile station that subscribes to the alternative ringback feature with unconditional call forwarding applied. Steps S211-S218 are the same as or similar to steps S191-S198 of FIG. 13. At step S219, the HLR returns a locreq request to the O-MSC. The parameters and usage are summarized in the following table.

| Parameter | Usage |
|---|---|
| RDIND | Indicates call forwarding service as the reason |
| | for forwarding the call. |
| TERMLIST | Contains a PSTNTermination containing |
| | DestinationDigits set to the forward-to number. |
| TRIGADDRLIST | Set to arm the |
| | Calling_Routing_Address_Available, |
| | O_Answer, and O_Disconnect triggers. |

At step S220, the O-MSC detects the Calling_Routing_Address_Available trigger and sends a ANLYZD message to the prepaid SCP associated with the mobile subscriber. The TriggerType parameter is set to indicated that the Calling_Routing_Address_Available trigger was detected. At step S221, the SCP sends an anlyzd message to the O-MSC. Steps S222-S226 are the same as steps S48-S52 of FIG. 4. At step S227, the O-MSC detects the O_Answer trigger and sends an OANSWER message to the prepaid SCP associated with the mobile subscriber.

While the foregoing has described exemplary embodiments, it is to be understood that various modifications may be made therein and that the implementation may be made in various forms and embodiments, and that it may be applied in numerous applications, only some of which have been described herein. For example, alternative ringback audio presentations may be employed in any communication system in which a waiting period occurs between initiation and completion of a communication link among two or more communication devices. It is intended by the following claims to claim all such modifications and variations which fall within the true scope of the invention.

1. In a telephone communications system comprising a plurality of mobile telephone stations, a plurality of base stations interfaced for wireless communications with the plurality of mobile stations, and a mobile switching center connected in a mobile telephone network to the base stations for controlling wireless telephone communications, a method for processing an incoming call from a caller for a mobile telephone station subscriber in response to receipt of the incoming call at a home or gateway mobile switching center for the subscriber, the method comprising the steps of:
determining whether the called mobile station subscriber subscribes to an alternative ringback feature,
establishing a call path to the caller between the subscriber mobile switching center and an audio content server if the mobile station subscriber subscribes to the alternative ringback feature;
transmitting a preselected audio presentation from the audio content server to the caller in lieu of audible ringback signals;
identifying the call location of the called subscriber station;
extending a call leg from the subscriber mobile switching center to the subscriber station or a subscriber call forwarding station;
in response to an answer of the call by the subscriber station or a subscriber call forwarding station, disconnecting the audio content server from the caller and connecting the caller to the call leg.

2. A method as recited in claim 1, wherein the step of determining whether the called mobile station subscriber subscribes to an alternative ringback feature comprises querying a home location register.

3. A method as recited in claim 1, wherein the step of identifying comprises querying a home location register.

4. A method as recited in claim 3, wherein the subscriber station is in a roaming location and the step of identifying further comprises establishing a temporary routing number for the subscriber station.

5. A method as recited in claim 3, wherein the step of establishing a call path to the audio content server comprises determining the network address of the audio content server from information contained in the home location register.

6. A method as recited in claim 1, wherein the step of transmitting a preselected audio presentation comprises accessing one of a plurality of stored audio presentations on the basis of subscriber identified criteria.

7. A method as recited in claim 6, wherein the subscriber identified criteria is related to the identity of the caller.

8. A method as recited in claim 6, wherein the subscriber identified criteria is related to the geographical location of the caller.

9. A method as recited in claim 6, wherein the subscriber identified criteria is related to the time of day of the incoming call to the subscriber mobile switching center.

10. A method as recited in claim 6, wherein the transmitted audio presentation is a musical selection.

11. A method as recited in claim 6, wherein the transmitted audio presentation is a prerecorded message.

12. A mobile telephone communications system comprising:
a plurality of base stations interfaced for wireless communications with a plurality of mobile stations;
a mobile switching center connected in a mobile telephone network to the base stations for controlling wireless telephone communications;
a home location register coupled to the mobile telephone network and having stored therein identification of mobile stations subscribed to the alternative ringback feature; and
an audio content server coupled to the mobile telephone network; wherein
in response to receipt of an incoming call at the mobile switching center, determination is made whether the called mobile station subscriber subscribes to an alternative ringback feature by a query to the home location register,
a call path is established to the caller between the subscriber mobile switching center and an audio content server if the mobile station subscriber subscribes to the alternative ringback feature;
a preselected audio presentation is transmitted from the audio content server to the caller in lieu of audible ringback signals;
the call location of the called subscriber station is identified;
a call leg is extended from the subscriber mobile switching center to the subscriber station or a subscriber call forwarding station; and
in response to an answer of the call by the subscriber station or a subscriber call forwarding station, the audio content server is disconnected from the caller and the caller is connected to the call leg.

13. A telecommunications system as recited in claim 12, wherein the audio content server comprises a plurality of stored audio presentations available for selection by subscribers to the alternative ringback feature to be transmitted during an incoming call and storage means for associating subscribers with selected audio presentations.

14. A telecommunications system as recited in claim 12, wherein the storage means contains subscriber identified criteria associating a plurality of stored presentations with a subscriber to the alternative ringback feature.

15. A telecomunications system as recited in claim 14, wherein the subscriber identified criteria is related to the identity of the caller.

16. A telecommunications system as recited in claim 14, wherein the subscriber identified criteria is related to the geographical location of the caller.

17. A telecommunications system as recited in claim 14, wherein the subscriber identified criteria is related to the time of day of the incoming call to the subscriber mobile switching center.

18. A method as recited in claim 12, wherein the transmitted audio presentation is a musical selection.

19. A method as recited in claim 12, wherein the transmitted audio presentation is a prerecorded message.
